(19) United States
(12) Patent Application Publication
(10) Pub. No.: US 2025/0387293 A1
(43) Pub. Date: Dec. 25, 2025

(54) Massage Device

(71) Applicant: Qing Ma, Chengdu (CN)

(72) Inventor: Qing Ma, Chengdu (CN)

(21) Appl. No.: 19/325,458

(22) Filed: Sep. 10, 2025

Related U.S. Application Data
(63) Continuation of application No. 19/301,916, filed on Aug. 15, 2025, now abandoned.

(30) Foreign Application Priority Data
Jul. 1, 2025 (DE) 202025103716.5

(51) Int. Cl. A61H 19/00; A61H 23/02

(52) U.S. Cl. CPC A61H 19/44; A61H 23/0254; A61H 2201/123; A61H 2201/169

(57) ABSTRACT

The present disclosure provides a massage device, including: a housing, a motor, and a telescopic component, wherein the motor and the telescopic component are arranged in the housing, and the motor is configured to drive the telescopic component to perform linear reciprocating motion along an axial direction of the housing. The massage device in the present disclosure has a simple structure and is easy to use, it can relax muscles in different parts of the body, effectively relieve fatigue, and enhance the pleasant feeling of human body massage.

### CROSS-REFERENCE TO RELATED APPLICATION

The present application claims priority to German patent application No. DE 202025103716.5, filed with the German Patent Office on Jul. 1, 2025, entitled “MASSAGE DEVICE”, the entire contents of which are incorporated herein by reference, and to U.S. patent application Ser. No. 19/301,916, filed with the USPTO on Aug. 15, 2025.

### TECHNICAL FIELD

The present disclosure relates to the field of health care massage products, and in particular to a massage device.

### BACKGROUND

In today's fast-paced lifestyle, human body massagers have received widespread attention and application as health-related auxiliary equipment for relieving fatigue, regulating emotions, and promoting blood circulation. Existing human body massagers mainly bring pressure and vibration stimulation to body parts by simulating human body massage techniques, such as kneading, patting and other massage actions.

Although massagers on the market currently have various styles and functions, their performance still needs to be continuously improved and the user experience needs to be optimized.

### SUMMARY

The present disclosure aims to provide a massage device which has a simple structure, is easy to use and can enhance the massage feeling.

In order to achieve the purpose of the present disclosure, the present disclosure provides a massage device, including: a housing, a motor, and a telescopic component. The motor and the telescopic component are arranged in the housing, and the motor is configured to drive the telescopic component to perform linear reciprocating motion along an axial direction of the housing.

Furthermore, the telescopic component includes a rotating bushing, a telescopic sleeve, and a sliding member. The rotating bushing is connected to an output end of the motor, the rotating bushing has an outer circumferential surface with a spiral groove, the telescopic sleeve is placed outside the rotating bushing, a part of the sliding member is placed in the spiral groove, and the other part is placed in an inner wall of the telescopic sleeve, the sliding member slides back and forth in the spiral groove as the rotating bushing rotates, and drives the telescopic sleeve to realize axial linear reciprocating motion.

Furthermore, the telescopic component further includes a guide sleeve, the rotating bushing is arranged in the guide sleeve, a longitudinal notch is provided on a side wall of the guide sleeve, the sliding member passes through the longitudinal notch of the guide sleeve and is placed in a recessed portion of the inner wall of the telescopic sleeve, and the sliding member and the telescopic sleeve perform linear reciprocating motion along the longitudinal notch.

Furthermore, an annular groove structure with a certain inclination angle along a longitudinal direction of the rotating bushing is formed on the outer circumferential surface of the rotating bushing.

Furthermore, the groove of the rotating bushing has a semicircular cross section.

Furthermore, the guide sleeve is fixed on the motor.

Furthermore, the inner wall of the telescopic sleeve has a longitudinal step-shaped protrusion matching the longitudinal notch of the guide sleeve, and a part of the sliding member is placed in a depression of the protrusion at a bottom of the telescopic sleeve.

Furthermore, the telescopic sleeve is open at one end and is sleeved outside the guide sleeve.

Furthermore, a first vibration motor is connected to the bottom of the telescopic sleeve.

Furthermore, the housing is in the shape of an elongated rod.

Furthermore, an upper end of the housing is open, and the telescopic sleeve is arranged at the open end of the housing.

Furthermore, a battery for supplying power to the motor and a control circuit board are further disposed in the housing.

Furthermore, the massage device further includes an elastic sleeve that wraps the housing, the telescopic sleeve, and the first vibration motor.

Furthermore, a second vibration motor is further provided in the elastic sleeve and is arranged at a certain angle to the housing.

The massage device of the present disclosure has the following beneficial effects:

The massage device provided by the present disclosure comprises a housing, a motor, and a telescopic component, the motor and the telescopic component are arranged in the housing, and the motor drives the telescopic component to perform linear reciprocating motion along the axis of the housing, so as to massage or stimulate parts of the human body, relax muscles in different parts of the body, effectively relieve fatigue, and enhance the pleasant feeling of human massage.

### BRIEF DESCRIPTION OF THE DRAWINGS

FIG. 1 is a perspective view of a massage device according to the present disclosure;

FIG. 2 is a schematic view of the components in the housing of the massage device of the present disclosure;

FIG. 3 is a schematic exploded view of the components in the housing of the massage device of the present disclosure;

FIG. 4 is a perspective view of the telescopic component of the massage device of the present disclosure;

FIG. 5 is a cross-sectional view of FIG. 4;

FIG. 6 is another perspective view of the massage device of the present disclosure.

In the drawings:

| | | |
|---|---|---|
| 1. Housing | 2. Motor | 3. Telescopic component |
| 31. Rotating bushing | 311. Groove | 32. Guide sleeve |
| 321. notch | 33. Telescopic | 331. Step-shaped |
| | sleeve | protrusion |
| 3311. Through Hole | 332. Gasket | 34. Sliding member |
| 4. First vibration motor | 5. Battery | 6. Control circuit board |
| 7. Second vibration motor | 8. Reducer | 9. Elastic sleeve |
| 10. Connecting rod | 11. Charging | |
| | socket | |

### DETAILED DESCRIPTION OF EMBODIMENTS

Embodiments of the present disclosure are described below with reference to the accompanying drawings. Elements and features described in one drawing or one embodiment of the present disclosure may be combined with elements and features shown in one or more other drawings or embodiments. It should be noted that for the purpose of clarity, the representation and description of components or processes that are not related to the present disclosure and are known to those of ordinary skill in the art are omitted in the drawings and descriptions.

The drawings in the present disclosure are schematic views, and the configurations of the various elements of the present application and their relative sizes are for illustration only. When terms such as “upper” and “lower”, “upward” or “downward”, “above” and “below”, “top” and “bottom”, “left” or “right” or similar relative expressions are used, these only refer to the arrangement of elements or structures in the drawings, and not necessarily to actual use. Obviously, if an object is turned over or simply viewed from a different angle, “downward” may become “upward”.

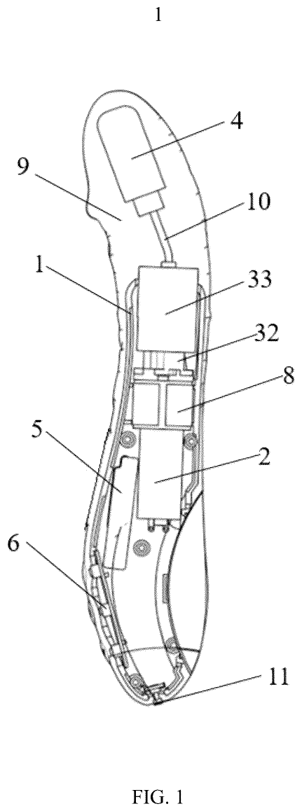

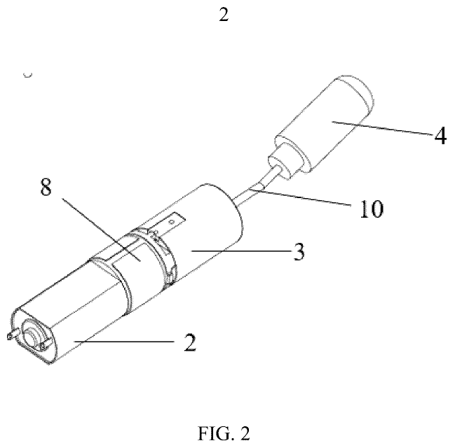

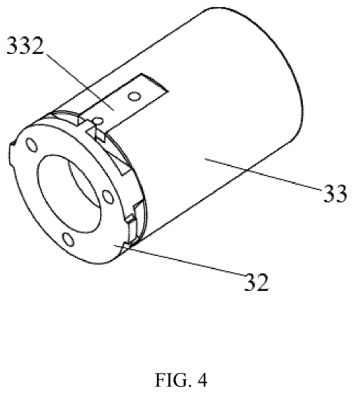

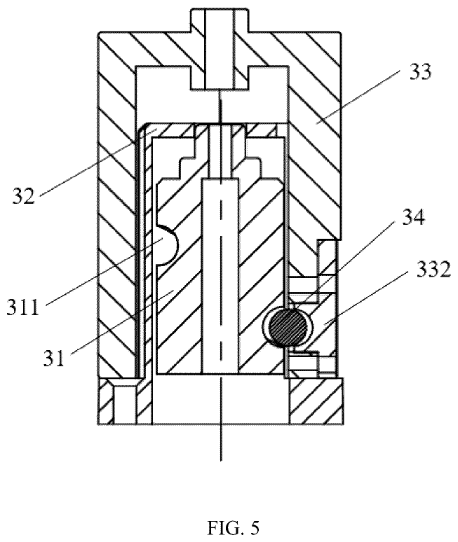

The massage device of the present disclosure is further described below in conjunction with FIGS. 1-6.

As shown in FIGS. 1 to 5, the massage device in this embodiment includes: a housing 1, a motor 2, and a telescopic component 3. The motor 2 and the telescopic component 3 are arranged in the housing 1, and the motor 2 drives the telescopic component 3 to perform linear reciprocating motion along the axial direction of the housing 1.

The telescopic component 3 includes a rotating bushing 31, a telescopic sleeve 33, and a sliding member 34. The rotating bushing 31 is connected to the output end of the motor 2. The rotating bushing 31 is roughly cylindrical and rotates around the axis of the motor under the drive of the motor 2. The outer circumferential surface of the rotating bushing 31 has a spiral groove 311. The telescopic sleeve 33 is placed outside the rotating bushing 31. A part of the sliding member 34 is placed in the groove 311, and the other part is placed in the inner wall of the telescopic sleeve 33. The sliding member 34 slides back and forth in the groove 311 as the rotating bushing 33 sleeve rotates, and drives the telescopic sleeve 33 to achieve axial linear reciprocating motion.

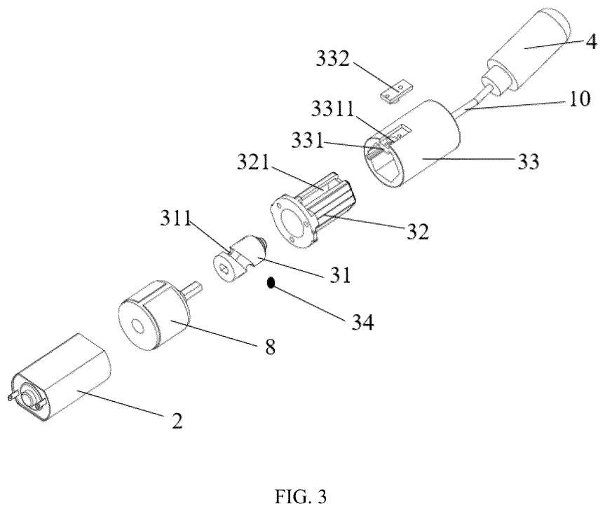

As can be seen from FIGS. 3 to 5, the telescopic component 3 also includes a guide sleeve 32, the rotating bushing 31 is arranged in the guide sleeve 32, and a longitudinal notch 321 is provided on the side wall of the guide sleeve 32. The sliding member 34 passes through the notch 321 of the guide sleeve 32 and is placed in a recessed portion of the inner wall of the telescopic sleeve 33. The sliding member 34 and the telescopic sleeve 33 perform linear reciprocating motion along the longitudinal notch 321.

The inner wall of the telescopic sleeve 33 has a longitudinal step-shaped protrusion 331 that matches the longitudinal notch 321 of the guide sleeve 32. The height of the protrusion 331 is substantially the same as the height of the longitudinal notch 321. The guide sleeve 32 is placed in the telescopic sleeve 33. The longitudinal notch 321 of the guide sleeve 32 can play a certain positioning and guiding role. The step-shaped protrusion 331 of the telescopic sleeve 33 slides along the notch 321 to complete the up and down reciprocating motion. The shape of the outer wall of the guide sleeve 32 matches the internal shape of the telescopic sleeve 33, for example, the cross section is roughly circular or hexagonal, which ensures the smoothness and stability of the movement of the telescopic sleeve 33 and reduces movement noise.

The groove 311 of the rotating bushing 31 of this embodiment is obliquely formed on the outer circumferential surface of the rotating bushing 31. The closed structure that surrounds the outer circumferential surface of the rotating bushing along the longitudinal direction of the rotating bushing 31 can also be called an annular groove. One end of the annular groove is close to the motor 2, and the other end is far away from the motor 2. The height difference of the entire closed structure is roughly the travel distance of the axial linear reciprocating motion of the telescopic sleeve 33.

The groove 311 of this embodiment can be of a semicircular cross-section, which makes it easier for the sliding member 34 to slide back and forth in the groove 311 and makes it easier to process the groove. The shape and structure of the sliding member 34 are not limited, as long as it can move in the groove 311 and drive the axial movement of the telescopic sleeve 33. Preferably, a sphere is used, with a portion of the sphere placed in the groove 311 of the rotating bushing and the other portion placed in the recessed portion of the inner wall of the telescopic sleeve 33.

In order to facilitate the assembly of the various components in the telescopic component 3, a through hole 3311 is provided on the step-shaped protrusion 331 of the telescopic sleeve 33, and the sliding member 34 is assembled into the groove 311 of the rotating bushing through the through hole 3311. At this time, a part of the sliding member 34 is placed in the groove 311, and the other part is placed in the gasket 332. The gasket 332 places the sliding member 34 in the space formed by the groove 311 and the through hole 3311, and it is fixed in a concave space of the outer wall of the telescopic sleeve 33. The gasket 332 of this embodiment is roughly a T-shaped stepped sheet structure, and the surface of the step is concave, for placing the sliding member 34 (ball). In this way, when the sliding member 34 slides up or down along the groove in the groove 311, it also drives the gasket 332 and the telescopic sleeve 33 to complete linear reciprocating motion.

In order to realize the different working modes of the entire massage device, the speed of the motor 2 is adjustable. The motor 2 is connected to the rotating bushing 31 through the output shaft of the reducer 8. The rotating bushing 31 can present different rotation speed modes, thereby driving the telescopic sleeve 33 to form different reciprocating motion speed modes. In any case, the guide sleeve 32 is fixed to the reducer 8 and remains stationary.

As shown in FIG. 1, the housing 1 is in the shape of an elongated rod with an opening at the upper end. The housing 1 can be composed of an upper housing and a lower housing that are buckled together to form a certain space, in which the motor 2 and the telescopic component 3 can be placed. The telescopic sleeve 33 is arranged at the open end of the housing 1. When the telescopic sleeve 33 reciprocates, it will extend out of the housing 1. The telescopic sleeve 33 is open at one end, specifically it has a sleeve-shaped structure with an opening at the lower part. Its bottom is connected to the first vibration motor 4 through a connecting rod 10. The first vibration motor 4 can move with the telescopic sleeve. At the same time, the first vibration motor 4 is also independently controlled by the control circuit board to achieve vibrations of different modes. Vibration is generated by the movement of the vibration motor, so that the user's body parts are further massaged to achieve muscle relaxation.

The housing 1 also includes a battery 5 for supplying power to the motor and a control circuit board 6. The control circuit board 6 includes a control portion and an operation buttons for starting, stopping and operating the telescopic component.

The massage device of this embodiment also includes an elastic sleeve 9, which wraps around the outside of the housing 1 and wraps the telescopic sleeve 33 and the first vibration motor 4 to form a complete structure. Operation buttons can be provided on its outer surface for operating the control circuit board 6, including a power switch, a telescopic sleeve control button and a vibration motor control button.

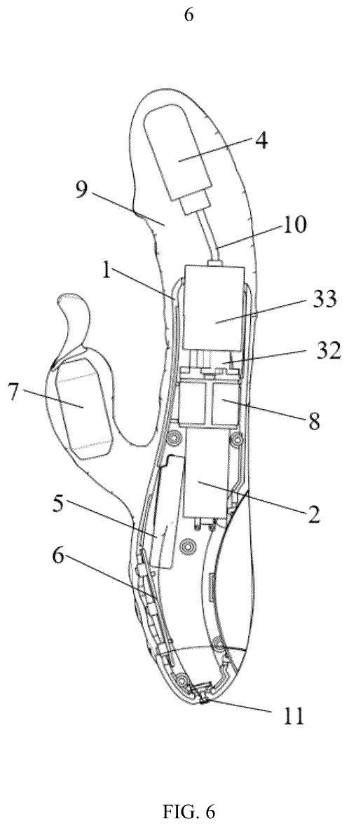

FIG. 6 is another schematic view of the massage device of the present disclosure. The basic structure is the same as that of the massage device shown in FIG. 1, except that the elastic sleeve 9 has a different outer structure, a second vibration motor 7 is further provided in the elastic sleeve 9. The second vibration motor 7 is separately provided at a certain angle to the housing 1, so that the user can massage different parts of the body at the same time and obtain a more pleasant feeling and experience when using it.

The motor 2, the first vibration motor 4 and the second vibration motor 7 of the massage device of the present disclosure can be powered by an internal or external power supply, and the housing 1 is provided with a battery 5 therein. A charging socket 11 matching with the battery 5 is provided at the bottom of the housing 1, and the battery 5 can be charged by connecting an external power supply.

In order to improve the use effect for the user, the shape of the elastic sleeve 9 can be humanized, for example, ergonomic, so that the user can use it more comfortably. The elastic sleeve can be made of elastic materials such as modified plastics, rubber or silicone, for example, silicone, EVA and other elastic materials, preferably silicone, which has good flexibility and elasticity, good skin-friendly performance, high mechanical strength, and is not easy to wear, and is suitable for contacting human body parts.

In case where the massage device of the present disclosure is used, when the user turns on the power and starts the motor 2, it drives the rotating bushing 31 to rotate, the sliding member 34 in the annular groove of the rotating bushing 31 slides back and forth, and drives the telescopic sleeve 33 to move up and down along the axial direction of the housing 1. The sliding member 34 slides in a complete annular groove, and the telescopic sleeve 33 can complete an up and down reciprocating linear motion, and drive the elastic sleeve 9 to achieve telescopic motion. The first vibration motor 4 and the second vibration motor 7 can also be started to generate vibration.

The massage device provided by the present disclosure can massage or stimulate parts of the human body through the telescopic movement and vibration of the elastic sleeve, so as to relax the muscles of different parts of the body, effectively relieve fatigue, and enhance the pleasant feeling of human body massage. It is particularly emphasized that the massage device of the present disclosure can be used as a device for sexual stimulation.

Although the present disclosure and its advantages have been described in detail, it should be understood that various changes, substitutions and conversions can be made without exceeding the spirit and scope of the present disclosure defined by the attached claims. Moreover, the scope of the present application is not limited to the specific embodiments of the process, equipment, means, method and steps described in the specification. It will be easily understood by those of ordinary skill in the art from the disclosure of the present application that, according to the present disclosure, existing and future processes, equipment, means, methods or steps that perform substantially the same functions as the corresponding embodiments described herein or obtain substantially the same results as the corresponding embodiments described herein can be used. Therefore, the attached claims are intended to include such processes, equipment, means, methods or steps within their scope.

What is claimed is:

1. A massage device, comprising: a housing, a motor, and a telescopic component, wherein the motor and the telescopic component are arranged in the housing, and the motor is configured to drive the telescopic component to perform linear reciprocating motion along an axial direction of the housing.

2. The massage device according to claim 1, wherein the telescopic component comprises a rotating bushing, a telescopic sleeve, and a sliding member, the rotating bushing is connected to an output end of the motor, the rotating bushing has an outer circumferential surface with a spiral groove, the telescopic sleeve is placed outside the rotating bushing, a part of the sliding member is placed in the spiral groove, and the other part is placed in an inner wall of the telescopic sleeve, the sliding member slides back and forth in the spiral groove as the rotating bushing rotates, and drives the telescopic sleeve to realize axial linear reciprocating motion.

3. The massage device according to claim 2, wherein the telescopic component further comprises a guide sleeve, the rotating bushing is arranged in the guide sleeve, a longitudinal notch is provided on a side wall of the guide sleeve, the sliding member passes through the longitudinal notch of the guide sleeve and is placed in a recessed portion of the inner wall of the telescopic sleeve, and the sliding member and the telescopic sleeve perform linear reciprocating motion along the longitudinal notch.

4. The massage device according to claim 2, wherein an annular groove structure with a certain inclination angle along a longitudinal direction of the rotating bushing is formed on the outer circumferential surface of the rotating bushing.

5. The massage device according to claim 3, wherein the inner wall of the telescopic sleeve has a longitudinal step-shaped protrusion matching the longitudinal notch of the guide sleeve, and a part of the sliding member is placed in a depression of the protrusion at a bottom of the telescopic sleeve.

6. The massage device according to claim 2, wherein the telescopic sleeve is open at one end and is sleeved outside the guide sleeve.

7. The massage device according to claim 6, wherein the guide sleeve is fixed on the motor.

8. The massage device according to claim 2, wherein a first vibration motor is connected to a bottom of the telescopic sleeve.

9. The massage device according to claim 2, wherein an upper end of the housing is open, and the telescopic sleeve is arranged at an open end of the housing.

10. The massage device according to claim 1, wherein a battery for supplying power to the motor and a control circuit board are further disposed in the housing.

11. The massage device according to claim 9, further comprising an elastic sleeve, wrapping the housing, the telescopic sleeve, and the first vibration motor.

12. The massage device according to claim 11, wherein a second vibration motor is further provided in the elastic sleeve and is arranged at a certain angle to the housing.
